(19) United States
(12) Patent Application Publication
(10) Pub. No.: US 2018/0152485 A1
(43) Pub. Date: May 31, 2018

(54) METHODS AND SYSTEMS FOR INTERNET PROTOCOL MULTIMEDIA SUBSYSTEM (IMS) DEREGISTRATION

(71) Applicant: GM GLOBAL TECHNOLOGY OPERATIONS LLC, Detroit, MI (US)

(72) Inventors: BONNIE CHEN, COLLEYVILLE, TX (US); SCOTT T. DROSTE, WEST BLOOMFIELD, MI (US)

(73) Assignee: GM GLOBAL TECHNOLOGY OPERATIONS LLC, Detroit, MI (US)

(21) Appl. No.: 15/363,039

(22) Filed: Nov. 29, 2016

(51) Int. Cl. H04L 29/06

(52) U.S. Cl. CPC H04L 65/1016; H04L 65/1069

(57) ABSTRACT

Methods and systems are provided for a telematics system capable of performing a deregistration of a device with an internet protocol multimedia subsystem (IMS) responsive to a detected voice capability over packet connection is supported by a target network. In an embodiment, a telematics system includes a memory comprising processor readable instructions for deregistering with an internet protocol multimedia subsystem (IMS) communicatively coupled to the telematics system, and a processor. In the embodiment, the telematics system determines when the telematics system is IMS registered with the IMS, and deregisters the telematics system with the IMS when a change of wireless radio access type and did not receive indicator of voice capability over packet connection by a respective target network.

### TECHNICAL FIELD

The technical field generally relates to communications systems, and more particularly relates to methods and systems for internet protocol multimedia subsystem (IMS) deregistration.

### BACKGROUND

Wireless voice communication may be generally described as communications between an originating device and a receiver. Often the receiver is a proprietary network, referred to herein as a call center. A carrier network, made up of a serving network and a target network, generally establishes the voice communication “connection” between the device and call center. The components of the carrier network interact in accordance with published standards in order to establish and maintain the wireless voice communication connection. The serving network often includes a server that operates according to cellular voice communication standards such as Long-Term Evolution (LTE), fourth generation (4G), or fourth generation and beyond (4G+), each of which requires the originating device to register with the server prior to commencing wireless voice communication. The server may be referred to, or be a part of, an internet protocol multimedia subsystem (IMS). Registration of the device with the IMS is referred to as IMS registration.

Generally, the device includes an appropriate wireless communication transceiver and continues wireless voice communication by periodically IMS registering, thereby confirming IMS registration of the device. While the device is registered with the serving network, it occupies bandwidth of the server. The device may further be a mobile platform or contained within portable housing capable of changing its geographic location. In some scenarios, the device moves from an area associated with a first target network to an area associated with a second target network. When the first target network supports voice communications, and the second target network supports voice communications, the switchover may be undetectable by a user of the device, voice communication continues uninterrupted, and the IMS registration is fully utilized. In contrast, when the first target network supports voice communications, but the second target network does not support voice communications, voice communication halts. Although the voice communication halts, the device may stay registered with the serving network for an additional thirty minutes to two hours after voice capability is lost, before the device is IMS deregistered. During the time in which there is no voice capability but the device is IMS registered, the IMS registration by the device is a disutility, is inefficient for the server, and reduces server capacity. Since the server associated with the serving network has finite bandwidth, any time during which a device stays registered, but is not utilizing voice capability is inefficient.

Accordingly, it is desirable to provide methods and systems that detect a loss of voice capability by a target network and utilize the detected loss of voice capability by the target network to promptly perform IMS deregistration. Furthermore, other desirable features and characteristics of the present invention will become apparent from the subsequent detailed description and the appended claims, taken in conjunction with the accompanying drawings and the foregoing technical field and background.

### SUMMARY

A telematics system is provided. The telematics system comprises: a memory comprising processor readable instructions for performing a deregistration with an internet protocol multimedia subsystem (IMS) communicatively coupled to the telematics system; and a processor coupled to the memory, and configured to be coupled to the IMS, and a target network, the processor further configured to: determine when the telematics system is IMS registered with the IMS, and when the telematics system is IMS registered, deregister the telematics system with the IMS responsive to receiving an asserted indicator of a loss of voice capability.

Also provided is a method for use in a telematics system, the method comprises: at a processor coupled to an internet protocol multimedia subsystem (IMS) and a memory, the memory comprising processor readable instructions for deregistration with the IMS, subsequent to determining that the telematics system is registered with the IMS: receiving an indicator of a loss of voice capability by a target network in operable communication with the telematics system; deregistering the telematics system with the IMS responsive to receiving the asserted loss of voice capability by the target network; and deregistering the telematics system with the IMS when a change of wireless radio access type and an loss of voice capability by the target network is not received by the telematics system.

A mobile platform is also provided. The mobile platform comprises: a wireless communication interface in operable communication with an internet protocol multimedia subsystem (IMS), and configured to detect a loss of voice capability by a target network in operable communication with the IMS; a memory comprising processor readable instructions for performing a deregistration with the IMS; a processor coupled to the memory and the wireless communication interface, the processor configured to determine when the device is registered with the IMS, and deregister the device with the IMS responsive to an indication that voice capability is not supported by the target network.

Furthermore, other desirable features and characteristics of the system and method will become apparent from the subsequent detailed description and the appended claims, taken in conjunction with the accompanying drawings and the preceding background.

### DESCRIPTION OF THE DRAWINGS

Exemplary embodiments will hereinafter be described in conjunction with the following drawing figures, wherein like numerals denote like elements, and wherein:

FIG. 1 is a diagram that illustrates various lines of communication within a communication system in accordance with various embodiments;

FIG. 2 is a functional block diagram of a communication system in accordance with various embodiments; and

FIG. 3 is a flow chart depicting a process that may be implemented by the communication system in FIG. 2, in accordance with various embodiments.

### DETAILED DESCRIPTION

Various embodiments of the present disclosure are disclosed herein. The disclosed embodiments are merely examples that may be embodied in various and alternative forms, and combinations thereof. The following detailed description is merely exemplary in nature and is not intended to limit the application and uses. The word “exemplary” is used exclusively herein to mean “serving as an example, instance, or illustration.” Any embodiment described herein as “exemplary” is not necessarily to be construed as preferred or advantageous over other embodiments. As used herein, for example, “exemplary” and similar terms, refer expansively to embodiments that serve as an illustration, specimen, model or pattern. Furthermore, there is no intention to be bound by any expressed or implied theory presented in the preceding technical field, background, brief summary or the following detailed description.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In some instances, well-known components, systems, or methods have not been described in detail in order to avoid obscuring the present disclosure. Therefore, specific operational and functional details disclosed herein are not to be interpreted as limiting, but merely as a basis for the claims and as a representative basis for teaching one skilled in the art.

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

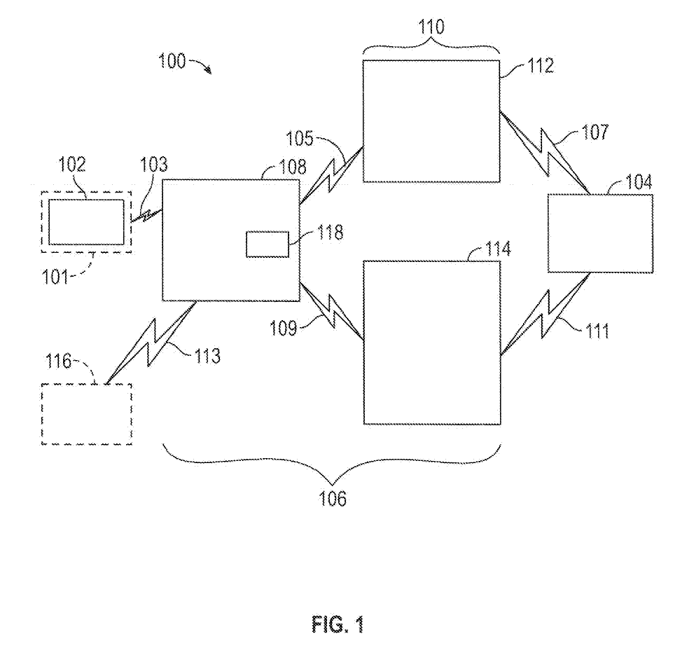

Turning now to FIG. 1, a communication system 100 is shown having a device 102 in operable communication with a call center 104. The components coupling the device 102 to the call center 104 via wireless communication include a carrier network 106, which comprises a serving network 108 and a target network array 110. The serving network 108 comprises an IMS 118. Although the target network array 110 may comprise a plurality of individual target networks, for simplicity, only a first target 112 and a second target 114 are shown. The significance and operation of each of these components, in accordance with various disclosed embodiments, are described below.

As mentioned, the device 102 may be a mobile platform capable of changing its geographic position (for example, a cellular phone or vehicle) and is capable of wireless voice communication. Wireless voice communication is generally provided in accordance with standardized high speed wireless communication protocols and systems that are voice packet capable. Some non-limiting examples of high speed wireless communication protocols include standards generated by the third generation partnership program (3GPP), such as Long-Term Evolution (LTE), fourth generation (4G), and fourth generation and beyond (4G+).

For the purpose of the example, it is desirable for device 102 to have wireless voice communication with the call center 104. As an initial condition, wireless communication 103 provides operable communication between device 102 and serving network 108; wireless communication 105 provides operable communication between serving network 108 and first target 112; and wireless communication 107 provides operable communication between the first target and the call center 104. The device 102 is capable of performing IMS registration, and is IMS registered with the IMS 118 within the serving network 108. The first target 112 is voice capable, so the device 102 and call center 104 exchange voice communication. Continuing with the example, the device 102 moves from a first geographic location 101 to a second geographic location 116 that is different than the first geographic location. In doing so, the device 102 exits an area of voice capable service provided by the first target 112, and enters into an area of service provided by the second target 114, which does not provide voice capability.

In the second geographic location 116 associated with the second target, wireless communication 113 provides operable wireless communication between device 102 and the IMS 118 within the serving network 108; wireless communication 109 provides operable communication between serving network 108 and second target 114; and wireless communication 111 provides operable communication between the second target and the call center 104. It is to be appreciated that, although the serving network 108 and the target networks of the target network array 110 are referred to herein as having an associated “area” of service, in actuality they provide a three dimensional volume of service, generally surrounding a centrally located antenna, and the volume of service has edges that taper off rather than discreetly end.

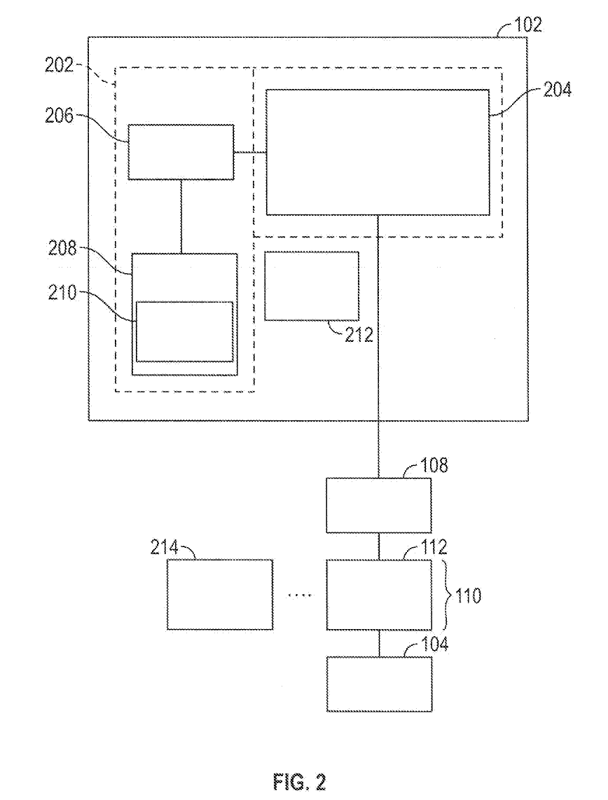

Referring next to FIG. 2, a functional block diagram of the device 102 within a communication system 200 is provided. The device 102 includes a telematics system 202 which may or may not integrally incorporate a wireless communication interface 204. The telematics system 202 comprises a processor 206 and a memory 208. Memory 208 may be pre-programmed with instructions 210, or may undergo a programming cycle in which the instructions 210 are downloaded into the memory 208. The instructions 210 are described in more detail below.

The wireless communication interface 204 includes at least one receiver and at least one transmitter that are operatively coupled to at least one processor such as processor 206. The wireless communication interface 204 can enable the device 102 to establish and maintain one or more wireless communications links (e.g., via cellular communications, Wireless Local Area Network (WLAN), Bluetooth™, and the like). The wireless communication interface 204 can perform signal processing (e.g., digitizing, data encoding, modulation, etc.) as is known in the art.

Wireless communication interface 204 can generally be any public or private access point that provides an entry/exit point for onboard telematics system 202 to communicate with long-range communication nodes (e.g., carrier networks 106, comprising serving network 108 base stations, target network array 110 base stations, communication satellites, and the like) that are communicatively coupled to the wireless communication interface 204, such as one or more of a cellular telephone network and the Internet. The long-range communication nodes allow the device 102, and the call center 104 to communicate with each other to share data, such as packetized voice data in support of voice capability. In some embodiments, the wireless communication interface 204 is integrated with the telematics system 202.

The telematics system 202 includes at least one computer processor 206 that is in communication with a tangible, non-transitory computer-readable storage medium (e.g., computer memory 208) by way of a communication bus or other such computing infrastructure. The processor 206 is illustrated in one block, but may include various different processors and/or integrated circuits that collectively implement any of the functionality described herein. The processor 206 includes a central processing unit (CPU) that is in communication with the memory 208. An I/O interface (not illustrated) may be any entry/exit device adapted to control and synchronize the flow of data into and out of the CPU from and to peripheral devices such as input/output devices.

The memory 208 can include any known form of computer-usable or computer-readable (storage) medium. The computer-readable (storage) medium of memory 208 can be any type of memory technology including any types of read-only memory or random access memory or any combination thereof. This encompasses a wide variety of media that include, for example but not limited to, an electronic, magnetic, optical, electromagnetic, infrared, or semiconductor system, apparatus, device, or propagation medium. Some non-limiting examples can include, for example, volatile media, non-volatile media, removable media, and non-removable media. The term computer-readable medium and variants thereof, as used in the specification and claims, refer to any known computer storage media. In some embodiments, storage media includes volatile and/or non-volatile, removable, and/or non-removable media. For example, storage media could include any of random-access memory (RAM), read-only memory (ROM), electrically erasable programmable read-only memory (EEPROM), solid state memory or other memory technology, CD ROM, DVD, other optical disk storage, magnetic tape, magnetic disk storage or other magnetic storage devices, and any other medium that can be used to store desired data. For sake of simplicity of illustration, the memory 208 is illustrated as a single block within telematics system 202; however, the memory 208 can be distributed throughout the device 102 including in any of the various blocks illustrated in FIG. 2, and can be implemented using any combination of fixed and/or removable storage devices depending on the implementation.

The memory 208 stores processor readable instructions 210 that, when executed by the processor 206, cause the processor 206 to perform various acts as described herein. The processor readable instructions 210 may be stored in the memory 208 distributed across or among one or more modules. The processor readable instructions 210 for registering with an IMS 118 and for deregistering from an IMS 118 can be loaded and executed at processor 206 as will be described in further detail below. The processor readable instructions 210 may be embodied in the form of one or more programs or applications (not shown in detail).

A navigation system 212 may also be present within the device 102. Navigation system 212 can include a global positioning system (GPS) device for establishing a global position of the vehicle. The GPS device includes a processor and one or more GPS receivers that receive GPS radio signals via an antenna (not shown). These GPS receivers receive differential correction signals from one or more base stations either directly or via a geocentric stationary or Low Earth Orbit (LEO) satellite, an earth-based station or other means. This communication may include such information as the precise location of a device 102, the latest received signals from the GPS satellites in view, road condition information, emergency signals, hazard warnings, device 102 velocity and intended path, and any other information. The navigation system 212 can also regularly receive information such as updates to the digital maps, weather information, road condition information, hazard information, congestion information, temporary signs and warnings, etc. from external sources.

In operation, the telematics system 202 can facilitate wireless communications, via the wireless communication interface 204, with an external communication network to IMS register and IMS deregister the telematics system 202 (example external communication networks include carrier networks 106, comprising serving network 108 base stations, target network array 110-n base stations, communication satellites, and the like). Exemplary external communication network communication protocols include, but are not limited to cellular networks such as LTE, 4G, and 4G+, Voice over Internet Protocol (VoIP) networks, LANs, wide area networks (WANs), personal area networks (PANs), and other communication networks. In some embodiments, wireless communication interface 204 may also support short wave communications, such as vehicle-to-vehicle (V2V) communications or vehicle-to-infrastructure, or V2I, communications.

In operation, the wireless communication interface 204 detects voice capability over packet connection, which may also be referred to in the industry as Voice over IP or Voice over Digital (this is referred to herein as “voice capability” for simplicity) of a respective target network of target network array 110 based, in part, on looking for flags within the signaling received from the target network of target network array 110. In operation, “detects voice capability” of a respective target network means that wireless communication interface 204 looks for and detects a RAT (radio access technology; e.g., 4G LTE, 3G UMTS/HSPA/WCDMA, 2G GSM) change and an indication from the respective target network that voice capability is not supported by the respective target network, this indication being a signal from the target network indicating the presence or lack of a “voice over PS session indicator” (VOPSSI) flag in the respective target network. A RAT change, as used herein, means a switch from one radio access technology to another, a loss of the radio access technology that has been in use, or a sudden presence of a radio access technology after it was previously not present.

Responsive to processing a combination of a RAT change and a voice capability indicator, the wireless communication interface 204 communicates the voice capability status to the processor 206 by asserting or de-asserting the “indicator of a loss of voice capability by the target network,” or “indicator of a loss of voice capability” for short. Accordingly, the wireless communication interface 204 may assert the indicator of a loss of voice capability by the respective target network responsive to, and indicative of, (i) a loss of access to the first target 112 subsequent to a movement of the device away from the first location 101, or (ii) a lack of voice capability of a second target 114 associated with a second location 116, determined subsequent to a movement of the device from the first location 101 to the second location 116. Subsequent to IMS deregistration, upon detecting a return of voice capability, the wireless communication interface 204 may de-assert the asserted indicator of the loss of voice capability. Responsive to the indicator of a loss of voice capability, the telematics system 202 performs IMS SIP de-registration (and registration), as described in more detail below.

The processor 206 determines, based on the indicator of the loss of voice capability, when to IMS register and when to IMS deregister with the IMS 118. The processor 206, coupled to the memory 208, the IMS 118, and a target network array 110, is configured to: register the device 102 with the IMS 118 by communicating with the IMS 118, via the wireless communication interface 204, in accordance with the instructions for performing registration with the IMS 118; determine when the telematics system 202 is IMS registered with the IMS 118; and deregister the telematics system 202 with the IMS 118 (i) responsive to receiving a signal from the target network confirming that voice capability is not supported by the target network in the target network array 110, and (ii) when a change of wireless radio access technology type is detected and the indicator of a loss of voice capability by the target network is not received by the telematics system (i.e., the signal from the target network confirming that voice capability is supported is not detected).

When voice capability is again detected, the indicator of a loss of voice capability is de-asserted by the wireless communication interface 204. The processor 206 is further configured to, when the asserted indicator of a loss of voice capability is de-asserted, communicate with the IMS 118, via the wireless communication interface 204, in accordance with the instructions for performing registration with the IMS, thereby re-registering the device with the IMS.

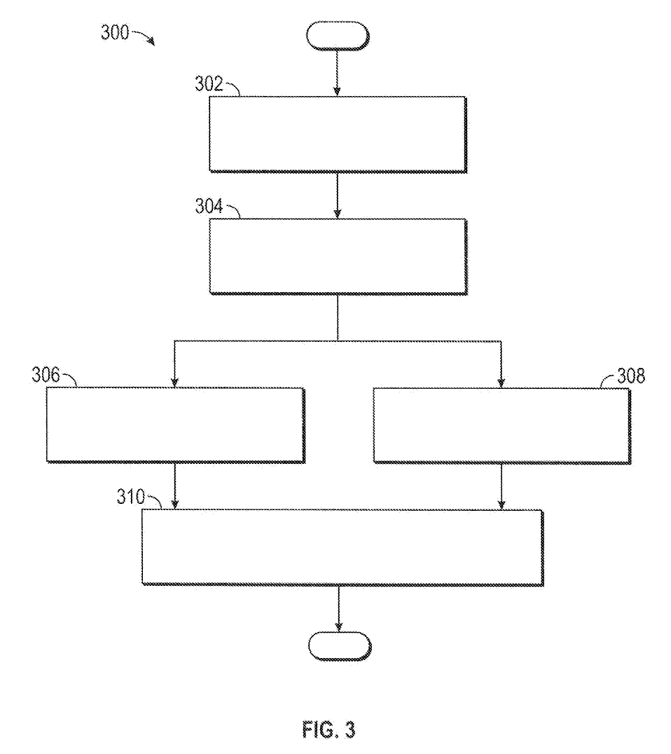

FIG. 3 is a flow chart depicting process steps 300 for a method that may be implemented by the communication system in FIG. 2, in accordance with various embodiments. It should be understood that process steps 300 are not necessarily presented in any particular order and that performance of some or all the steps in an alternative order is possible and is contemplated. The process steps 300 have been presented in the demonstrated order for ease of description and illustration. Further, steps can be added, omitted, and/or performed simultaneously without departing from the scope of the appended claims. In certain embodiments, some or all steps of this process, and/or substantially equivalent steps, are performed by execution of computer-readable instructions (such as instructions 210) which may be in the form of an algorithm stored or included on a computer-readable medium, such as memory 208. For instance, references to a processor performing functions of the present disclosure refer to any one or more interworking device 102 or telematics system 202 components executing processor readable instructions 210.

As mentioned, the instructions 210 within the telematics system 202 comprise the processor readable instructions for performing registration with the IMS 118, as well as the processor readable instructions for maintaining IMS registration once it is established. Wireless voice capable communication between device 102 and call center 104 is supported while the device 102 is IMS registered with the IMS 118. At 302, the telematics system 202 has IMS registered device 102 with the IMS 118.

In the course of wireless communication, the telematics system 202 is continually receiving a voice capability status of the respective target networks within the target network array 110. In the example described herein, once IMS registration is completed, voice capability is assumed affirmative (and IMS registration is maintained) until an asserted indicator of a loss of voice capability of the target network is received by the telematics system 202. For the duration of time that the indicator of a loss of voice capability of the target network is asserted, the target network array 110 is assumed not voice capable. When the indicator of a loss of voice capability of the target network is de-asserted, voice capability of the target network array 110 is again assumed, and the telematics system 202 may perform IMS registration, essentially re-registering the device 102 with the IMS 118.

As described above, target network array 110 may comprise a plurality of individual, independent target networks, such as the first target 112, the second target 114, and any number of additional target networks, to target network N 214, and each time wireless communication is established between the device 102 and the call center 104, it utilizes only one of the individual target networks within target network array 110. In the course of voice communication between device 102 and call center 104, as device 102 roams and moves among locations supported by the individual target networks (i.e., first target 112, second target 114) of target network array 110, as long as each individual target network is voice capable, voice communication is perceived, by a user of device 102, to be seamless or uninterrupted.

As described herein, the device 102 may roam, or move from a first location 101 associated with a first target 112 to a second location 116, associated with a second target 114; roaming does not interfere with the continual reception by the telematics system 202 of the status of the voice capability of the target network array 110. When device 102 moves to a second location within an area of service associated with a second target network that does not have voice capability, the telematics system 202 may detect the voice capability change or may receive a signal from the second target network (in the second area of service) indicating that voice capability is not supported by the second target network, and voice communication along the carrier network 106 is affected. In an alternative, if a target network (such as the first target) that was previously voice capable experiences a failure and becomes voice incapable, the telematics system 202 again receives a signal from the target network indicating a loss of voice capability by the target network, and voice communication along the carrier network 106 is affected.

The asserted indicator of a loss of voice capability by a respective target network in target network array 110 is generated by the wireless communication interface 204, responsive to detecting a loss of voice capability by the respective target network in target network array 110. In a transition between a first target and a second target, the loss of voice capability is detected by detecting a RAT change and a signal from the second target network that does not have the above mentioned indicator flag indicating that voice over PS session indicator (VOPSSI) is supported by the second target. Responsive thereto, the indicator of a loss of voice capability may asserted. Accordingly, the indicator of a loss of voice capability may indicate (i) an inability to confirm that the second target is voice capable at 306, for example, by not receiving a VOPSSI flag from the second target, or (ii) an ability to confirm, via reception a signal from the second target, a signal including a VOPSSI flag, indicating that the second target is not voice capable at 308. As mentioned above, it may be appreciated that an inability to confirm that a target is voice capable at 306 may also indicate a complete loss of access (by the telematics system 202) to the any target network within target network array 110, in other words, an incomplete carrier network 106.

Regardless of how the wireless communication interface 204 determine that voice capability is no longer supported in the carrier network communicatively coupling the device 102 to the call center 104, at 310, the telematics system 202 performs IMS deregistration with the IMS 118 responsive to the asserted indicator of a loss of voice capability by a target network. IMS deregistration includes performing the processor readable instructions for IMS deregistration; the processor readable instructions may involve a communication protocol via the wireless communication interface 204 and the IMS 118.

Those of skill in the art would further appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the description above includes a general context of computer-executable instructions, the present disclosure can also be implemented in combination with other program modules and/or as a combination of hardware and software. The terms “application,” “algorithm,” “program,” “instructions,” or variants thereof, are used expansively herein to include routines, program modules, programs, components, data structures, algorithms, and the like, as commonly used. These structures can be implemented on various system configurations, including single-processor or multiprocessor systems, microprocessor-based electronics, combinations thereof, and the like. Although various algorithms, instructions, etc. are separately identified herein, various such structures may be separated or combined in various combinations across the various computing platforms described herein.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The above-described embodiments are merely exemplary illustrations of implementations set forth for a clear understanding of the principles of the disclosure. The foregoing detailed description will provide those skilled in the art with a convenient road map for implementing the exemplary embodiment or exemplary embodiments. While exemplary embodiments have been presented in the foregoing detailed description, it should be appreciated that a vast number of variations exist.

The exemplary embodiments are only examples, and are not intended to limit the scope, applicability, or configuration of the disclosure in any way. Variations, modifications, and combinations may be made to the above-described embodiments without departing from the scope of the claims. For example, various changes can be made in the function and arrangement of elements without departing from the scope of the disclosure as set forth in the appended claims and the legal equivalents thereof. All such variations, modifications, and combinations are included herein by the scope of this disclosure and the following claims.

What is claimed is:

1. A telematics system comprising:
a memory comprising processor readable instructions for performing a deregistration with an internet protocol multimedia subsystem (IMS) communicatively coupled to the telematics system; and
a processor coupled to the memory, and configured to be coupled to the IMS, and a target network, the processor further configured to:
determine when the telematics system is IMS registered with the IMS, and
when the telematics system is IMS registered, deregister the telematics system with the IMS responsive to receiving an asserted indicator of a loss of voice capability.

2. A telematics system according to claim 1, further comprising:
a wireless communication interface in operable communication with the processor, the IMS, and the target network, the wireless communication interface configured to detect the voice capability of the target network and assert or de-assert the indicator of a loss of voice capability based thereon.

3. A telematics system according to claim 1, wherein the memory further comprises processor readable instructions for performing registration with the IMS; and
the processor is further configured to, when the indicator of a loss of voice capability is de-asserted, register the telematics system with the IMS.

4. A telematics system according to claim 3, wherein the indicator of a loss of voice capability, subsequent to determining that the telematics system is IMS registered, an inability to confirm that voice capability is supported by the target network.

5. A telematics system according to claim 4, wherein the indicator of a loss of voice capability further indicates, subsequent to determining that the telematics system is IMS registered, an ability to confirm that voice capability is not supported by the target network.

6. A telematics system according to claim 5, wherein the telematics system is located within a device capable of roaming, defined as moving from a first location to a second location.

7. A telematics system according to claim 6, wherein the target network is defined as a first target associated with the first location, and wherein the processor is further configured to:
subsequent to being IMS registered with the first target at the first location, receive an asserted indicator of a loss of voice capability indicative of
(i) a loss of access to the first target subsequent to a movement of the device away from the first location, or
(ii) a lack of voice capability of a second target associated with a second location, determined subsequent to a movement of the device from the first location to the second location.

8. A method for use in a telematics system, the method comprising:
at a processor coupled to an internet protocol multimedia subsystem (IMS) and a memory, the memory comprising processor readable instructions for deregistration with the IMS,
subsequent to determining that the telematics system is registered with the IMS:
receiving an indicator of a loss of voice capability by a target network in operable communication with the telematics system;
deregistering the telematics system with the IMS responsive to receiving the asserted loss of voice capability by the target network; and
deregistering the telematics system with the IMS when a change of wireless radio access type and an loss of voice capability by the target network is not received by the telematics system.

9. A method according to claim 8, wherein the memory further comprises processor readable instructions having a protocol for performing registration with the IMS; and
The method further comprises, when the indicator of the loss of voice is de-asserted, registering the telematics system with the IMS through a wireless communication interface in operable communication with the IMS and the target network.

10. A method according to claim 9, wherein deregistering the telematics system with the IMS comprises communicating with the IMS, via the wireless communication interface, and in accordance with the instructions for deregistration with the IMS.

11. A method according to claim 10, further comprising:
at the wireless communication interface,
detecting a loss of voice capability by the target network; and
asserting the indicator of the loss of voice capability responsive thereto.

12. A method according to claim 11, wherein detecting the loss of voice capability by the target network comprises a loss of ability to confirm that voice capability is supported by the target network.

13. A method according to claim 12, wherein detecting the loss of voice capability by the target network further comprises receiving a signal affirming that voice capability is not supported by the target network.

14. A method according to claim 13, wherein the telematics system is located within a device capable of roaming, defined as moving from a first location to a second location.

15. A method according to claim 14, wherein the target network comprises a first target associated with the first location, and further comprising:
subsequent to being IMS registered with the first target at the first location, asserting the indicator of voice capability over packet connection (i) responsive to a loss of access to the first target subsequent to a movement of the device away from the first location, or (ii) responsive to an indication of a lack of voice capability of a second target associated with a second location, determined subsequent to a movement of the device from the first location to the second location.

16. A method according to claim 15, further comprising:
subsequent to deregistering the IMS, de-asserting the indicator of a loss of voice capability by the target network responsive to detecting voice capability.

17. A mobile platform comprising:
a wireless communication interface in operable communication with an internet protocol multimedia subsystem (IMS), and configured to detect a loss of voice capability by a target network in operable communication with the IMS;
a memory comprising processor readable instructions for performing a deregistration with the IMS;
a processor coupled to the memory and the wireless communication interface, the processor configured to determine when the device is registered with the IMS, and deregister the device with the IMS responsive to an indication that voice capability is not supported by the target network.

18. A mobile platform according to claim 17, wherein the wireless communication interface is configured to:
detect the loss of voice capability by the target network and assert an indicator of a loss of voice capability therefrom; and
de-assert a previously asserted indicator of a loss of voice capability responsive to detecting voice capability.

19. A mobile platform according to claim 18, wherein:
the memory further comprises processor readable instructions for performing registration with the IMS; and
the processor is further configured to, register the telematics system with the IMS responsive to the de-asserted indicator of a loss of voice capability.

20. A mobile platform according to claim 19, wherein the indicator of voice capability over packet connection by the target network is indicative of (i) an inability to confirm that voice capability over packet connection is supported by the target network, or (ii) an ability to confirm that voice capability over packet connection is not supported by the target network.
